(19) United States
(12) Patent Application Publication
(10) Pub. No.: US 2006/0272305 A1
(43) Pub. Date: Dec. 7, 2006

(54) Channel filter

(76) Inventor: Jeffrey S. Morgan, Stoughton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/145,806

(22) Filed: Jun. 6, 2005

(51) Int. Cl. B01D 46/00

(52) U.S. Cl. 55/521

(57) ABSTRACT

A channel filter is provided by corrugated fluted flow channels folded back and forth transversely to the pleats.

### BACKGROUND AND SUMMARY

The invention relates to fluted filter elements and methods for making same.

Fluted filter elements are known in the prior art for filtering fluid flowing along an axial flow direction. The filter includes a plurality of axially extending fluted flow channels, including a first set of flow channels having closed upstream ends and open downstream ends, and a second set of flow channels having open upstream ends and closed downstream ends.

The present invention arose during continuing development efforts directed toward simplicity of construction, reliability, cost effective manufacture, and improved performance.

### BRIEF DESCRIPTION OF THE DRAWINGS

FIG. 1 is a perspective view of a filter constructed in accordance with the invention.

FIG. 2 is a perspective view of a sheet of filter media corrugated in a serpentine sinusoidal pattern, in an initial manufacturing step.

FIG. 3 shows a further manufacturing step for the filter media sheet of FIG. 2.

FIG. 4 shows a further manufacturing step for the filter media sheet of FIG. 3.

FIG. 5 shows a further manufacturing step for the filter media sheet of FIG. 4, to provide the filter element construction of FIG. 1.

FIG. 6 is a front elevation view of a portion of the filter of FIG. 1.

### DETAILED DESCRIPTION

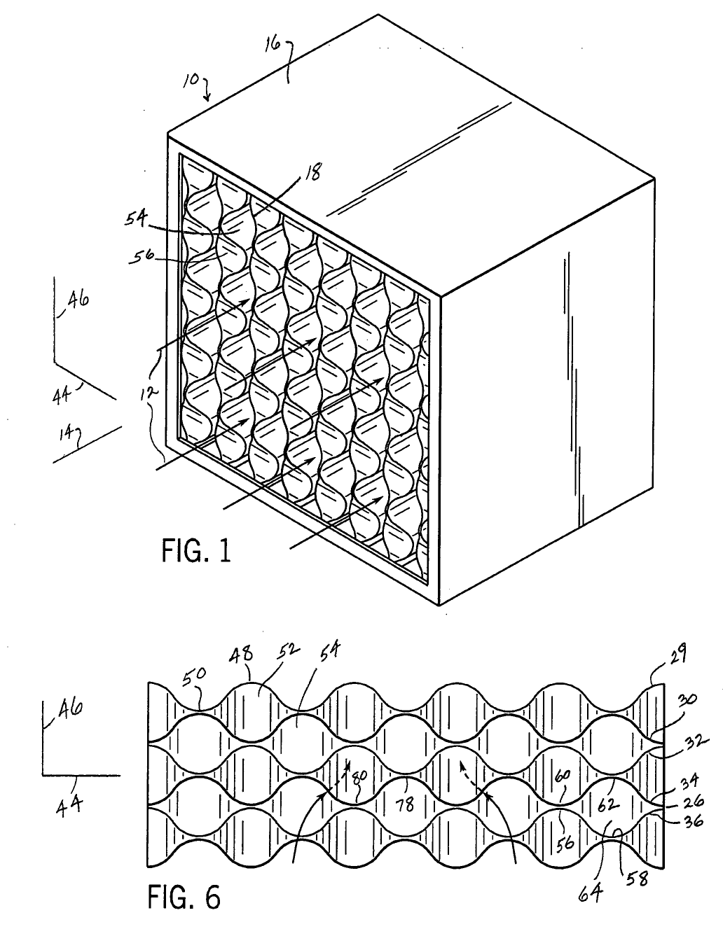

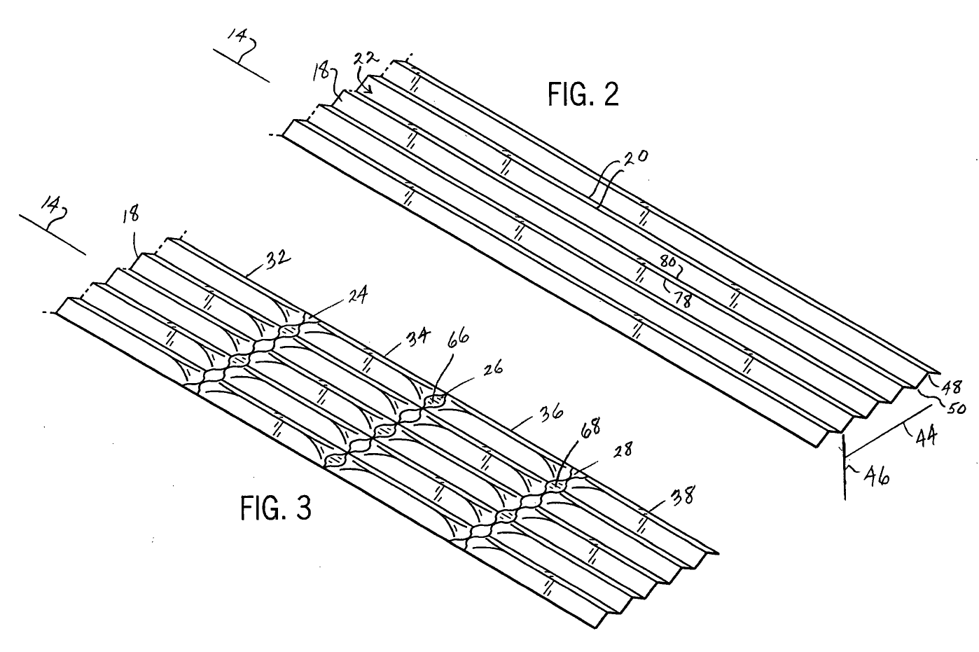

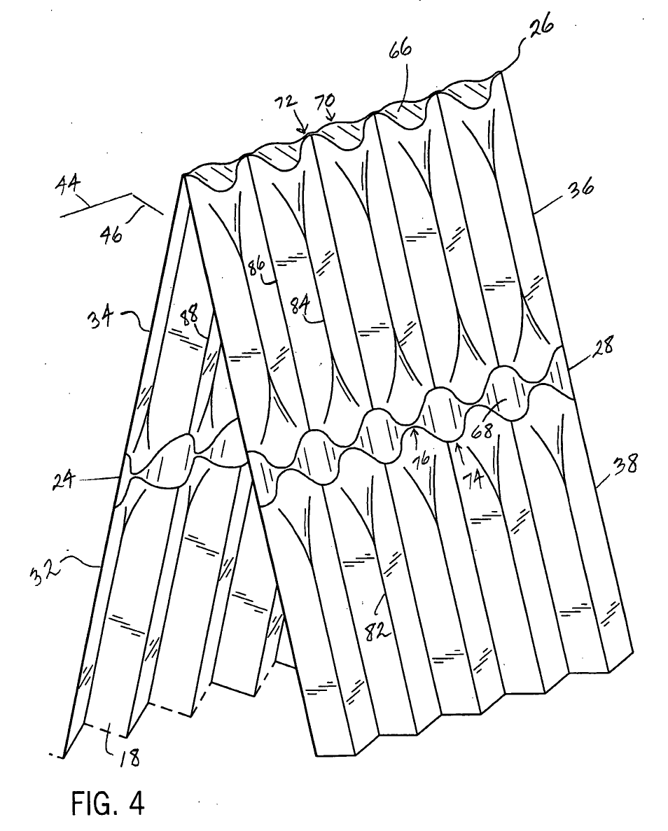

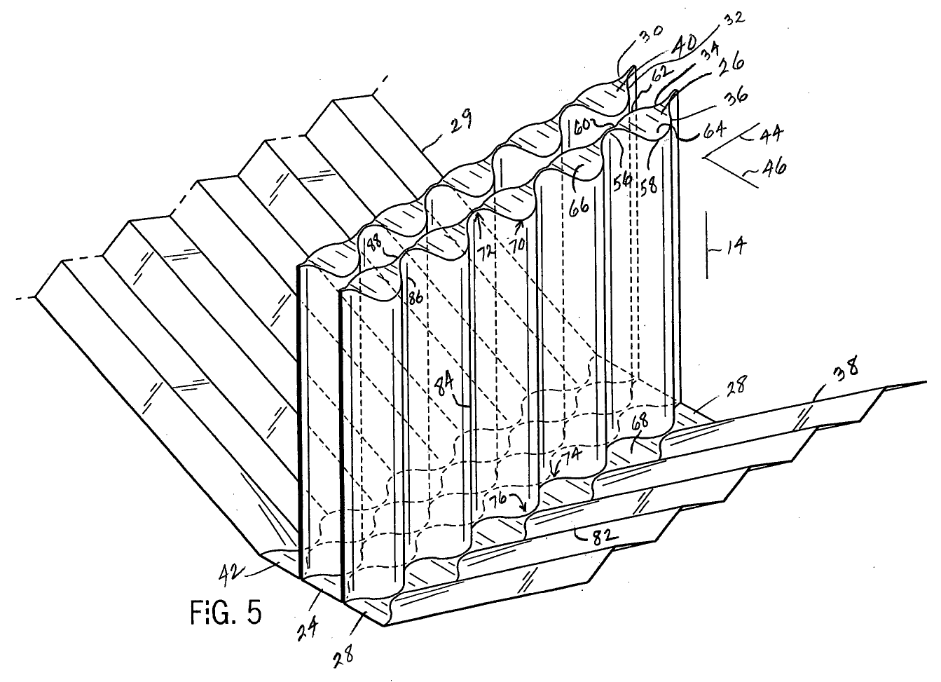

FIG. 1 shows a filter 10 for filtering fluid flowing along an axial flow direction as shown at arrows 12 along a flow axis 14 from upstream to downstream in a housing 16. Initially, a sheet 18 of filter media is corrugated, FIG. 2, in a serpentine sinusoidal pattern along a set of pleat bend lines 20 extending axially to form a plurality of axially extending fluted flow channels 22. The sheet then has a plurality of creases or folds such as 24, 26, 28, and so on, FIG. 3, formed laterally across the pleat bend lines, and the sheet is then folded back and forth, FIGS. 4, 5, upon itself along a plurality of runs 29, 30, 32, 34, 36, and so on, between the plurality of folds, including upstream folds at a first set of fold lines such as 26, 40, and so on, FIG. 5, and downstream folds at a second set of fold lines such as 28, 24, 42, and so on.

The sinusoidal pattern, FIGS. 2, 6, extends along an abscissa along a first lateral direction 44 relative to flow axis 14, and extends along an ordinate along a second lateral direction 46 relative to flow axis 14. The sinusoidal pattern has peaks and valleys 48 and 50 laterally varying from the noted abscissa along the direction of the noted ordinate. The noted first and second lateral directions 44 and 46 are perpendicular to each other. Each of first and second lateral directions 44 and 46 is perpendicular to flow axis 14. Fluted flow channels 22 include first and second sets 52 and 54 of alternating flow channels. The first set of flow channels 52 have closed upstream ends and open downstream ends. The second set of flow channels 54 have open upstream ends and closed downstream ends.

The peaks and valleys of a given run are laterally aligned along lateral direction 46 with the valleys and peaks, respectively, of an adjacent run to form the noted fluted flow channels. For example, referring to FIGS. 5 and 6, peaks and valleys 56 and 58 of run 36 are laterally aligned along lateral direction 46 with valleys and peaks 60 and 62, respectively, of adjacent run 34 to form flow channels 64.

The upstream ends of the first set of flow channels 52 are closed by upstream channel-closure face portions such as 66, FIGS. 3-5, of filter media sheet 18 facing axially and extending laterally in each of the noted first and second lateral directions 44 and 46 across a respective flow channel between a respective peak and valley. The downstream ends of the second set of flow channels 54 are closed by downstream channel-closure face portions such as 68 of filter media sheet 18 facing axially and extending laterally in each of the noted first and second lateral directions 44 and 46 across a respective flow channel between a respective peak and valley. Upstream channel-closure face portions 66 of filter media sheet 18 extend along the noted upstream folds along the noted first set of fold lines such as 26 along the noted first lateral direction 44 and alternate between maximum and minimum width sections 70 and 72 along a width dimension along second lateral direction 46. The maximum width sections 70 have a saddle shape spanning laterally along first lateral direction 44 between respective minimum width sections 72 and curved along an arc bowed in an axial flow direction, and spanning laterally along second lateral direction 46 between a respective peak and valley of adjacent runs such as 36 and 34, FIG. 4. Downstream channel-closure face portions 68 of filter media sheet 18 extend along the noted downstream folds along the noted second set of fold lines such as 28 along the noted first lateral direction 44 and alternate between maximum and minimum width sections such as 74 and 76 along a width dimension along the noted second lateral direction 46. Maximum width sections 74 of downstream channel-closure face portions 68 have a saddle shape spanning laterally along first lateral direction 44 between respective minimum width sections 76 and curved along an arc bowed in an axial flow direction, and spanning laterally along second lateral direction 46 between a respective peak and valley of adjacent runs such as 36 and 38. Upstream channel-closure face portions 66 of filter media sheet 18 span along first lateral direction 44 along the noted arc and are preferably bowed axially downstream into respective flow channels. Downstream channel-closure face portions 68 of filter media sheet 18 span along first lateral direction 44 along the noted arc and are preferably bowed axially upstream into respective flow channels. Pleat bend lines 20 along the noted serpentine sinusoidal pattern define pleat tips extending axially and having a shape which may be rounded (e.g. curved) or pointed. In the case of pointed pleat tips at bend lines 20, the noted serpentine sinusoidal pattern would have a diamond shape, and the noted saddle shape in the plane defined by lateral directions 44 and 46 would have pointed saddle tips rather than rounded, thus providing a dihedral shape. Upstream channel-closure face portions 66 of filter media sheet 18 are preferably the sole closure of the upstream ends of the first set of flow channels 52, eliminating the need for sealing the upstream ends of the first set of flow channels. Downstream channel-closure face portions 68 of filter media sheet 18 are preferably the sole closure of the downstream ends of the second set of flow channels 54, eliminating the need for sealing the downstream ends of the second set of flow channels.

Pleat bend lines 20, FIG. 2, include first and second subsets of axially extending pleat bend lines 78 and 80. The first subset of axially extending pleat bend lines 78 form the peaks of a given run, such as 34, FIG. 6, and are adjacent the valleys of an adjacent run such as 32. The second subset of axially extending pleat bend lines 80 form the valleys of the given run, such as 34, and are adjacent the peaks of an adjacent run such as 36. As illustrated in FIGS. 4 and 5, axially extending pleat bend lines such as 82 and 84 of the first subset abut each other along adjacent runs such as 36 and 38. Axially extending pleat bend lines such as 86 and 88 of the second subset abut each other along adjacent runs such as 36 and 34. The axially extending pleat bend lines of the first subset of a given run abut the axially extending pleat bend lines of the first subset of the adjacent run to one lateral side thereof along second lateral direction 46. The axially extending pleat bend lines of the second subset of the given run abut the axially extending pleat bend lines of the second subset of the adjacent run to the opposite lateral side along second lateral direction 46. The disclosed structural configuration enables higher usable filter media content per filter face area and volume.

It is recognized that various equivalents, alternatives and modifications are possible within the scope of the appended claims.

What is claimed is:

1. A filter for filtering fluid flowing along an axial flow direction along a flow axis from upstream to downstream, comprising a sheet of filter media corrugated in a serpentine sinusoidal pattern along a set of pleat bend lines extending axially to form a plurality of axially extending fluted flow channels, and folded back and forth upon itself along a plurality of runs between a plurality of folds including upstream folds at a first set of fold lines and downstream folds at a second set of fold lines, the serpentine sinusoidal pattern extending along an abscissa along a first lateral direction relative to said flow axis, and extending along an ordinate along a second lateral direction relative to said flow axis, the serpentine sinusoidal pattern having peaks and valleys laterally varying from said abscissa along the direction of said ordinate, said first and second lateral directions being perpendicular to each other, each of said first and second lateral directions being perpendicular to said flow axis, said fluted flow channels comprising first and second sets of alternating flow channels, said first set of flow channels having closed upstream ends and open downstream ends, said second set of flow channels having open upstream ends and closed downstream ends.

2. The filter according to claim 1 wherein the peaks and valleys of a given said run are laterally aligned along said second lateral direction with the valleys and peaks, respectively, of an adjacent run to form said fluted flow channels.

3. The filter according to claim 2 wherein:
said upstream ends of said first set of flow channels are closed by upstream channel-closure face portions of said filter media sheet facing axially and extending laterally in each of said first and second lateral directions across a respective flow channel between a respective peak and valley;
said downstream ends of said second set of flow channels are closed by downstream channel-closure face portions of said filter media sheet facing axially and extending laterally in each of said first and second lateral directions across a respective flow channel between a respective peak and valley.

4. The filter according to claim 3 wherein:
said upstream channel-closure face portions of said filter media sheet extend along said upstream folds along said first set of fold lines along said first lateral direction and alternate between maximum and minimum width sections along a width dimension along said second lateral direction, said maximum width sections having a saddle shape spanning laterally along said first lateral direction between respective minimum width sections and curved along an arc bowed in said axial flow direction and spanning laterally along said second lateral direction between a respective peak and valley of adjacent runs;
said downstream channel-closure face portions of said filter media sheet extend along said downstream folds along said second set of fold lines along said first lateral direction and alternate between maximum and minimum width sections along a width dimension along said second lateral direction, said maximum width sections of said downstream channel-closure face portions having a saddle shape spanning laterally along said first lateral direction between respective minimum width sections and curved along an arc bowed in said axial flow direction and spanning laterally along said second lateral direction between a respective peak and valley of adjacent runs.

5. The filter according to claim 4 wherein:
said upstream channel-closure face portions of said filter media sheet span along said first lateral direction along said arc and are bowed axially downstream into respective said flow channels;
said downstream channel-closure face portions of said filter media sheet span along said first lateral direction along said arc and are bowed axially upstream into respective said flow channels.

6. The filter according to claim 4 wherein said set of pleat bend lines along said serpentine sinusoidal pattern define pleat tips extending axially and having a shape selected from the group consisting of rounded pleat tips and pointed pleat tips.

7. The filter according to claim 4 wherein each of said saddle shapes has saddle tips selected from the group consisting of rounded tips and pointed tips.

8. The filter according to claim 7 wherein at least one of said saddle shapes is dihedral.

9. The filter according to claim 3 wherein:
said upstream channel-closure face portions of said filter media sheet are the sole closure of said upstream ends of said first set of flow channels, eliminating the need for sealing said upstream ends of said first set of flow channels;
said downstream channel-closure face portions of said filter media sheet are the sole closure of said downstream ends of said second set of flow channels, eliminating the need for sealing said downstream ends of said second set of flow channels.

10. A filter for filtering fluid flowing along an axial flow direction along a flow axis from upstream to downstream, comprising a sheet of filter media corrugated in a serpentine sinusoidal pattern along a set of pleat bend lines extending axially to form a plurality of axially extending fluted flow channels, and folded back and forth upon itself along a plurality of runs between a plurality of folds including upstream folds at a first set of fold lines and downstream folds at a second set of fold lines, the serpentine sinusoidal pattern extending along an abscissa along a first lateral direction relative to said flow axis, and extending along an ordinate along a second lateral direction relative to said flow axis, the serpentine sinusoidal pattern having peaks and valleys laterally varying from said abscissa along the direction of said ordinate, said first and second lateral directions being perpendicular to each other, each of said first and second lateral directions being perpendicular to said flow axis, the peaks and valleys of a given run being laterally aligned along said second lateral direction with the valleys and peaks, respectively, of an adjacent run to form said fluted flow channels, said fluted flow channels comprising first and second sets of alternating flow channels, said first set of flow channels having closed upstream ends and open downstream ends, said second set of flow channels having open upstream ends and closed downstream ends, said upstream ends of said first set of flow channels being closed by upstream channel-closure face portions of said filter media sheet facing axially and extending laterally in each of said first and second lateral directions across a respective flow channel between a respective peak and valley, said downstream ends of said second set of flow channels being closed by downstream channel-closure face portions of said filter media sheet facing axially and extending laterally in each of said first and second lateral directions across a respective flow channel between a respective peak and valley, said set of pleat bend lines comprising first and second subsets of axially extending pleat bend lines, wherein said first subset of axially extending pleat bend lines form the peaks of a given run and are adjacent the valleys of an adjacent run, and wherein said second subset of axially extending pleat bend lines form the valleys of said given run and are adjacent the peaks of an adjacent run, said axially extending pleat bend lines of said first subset abutting each other along adjacent runs, said axially extending pleat bend lines of said second subset abutting each other along adjacent runs.

11. The filter according to claim 10 wherein the axially extending pleat bend lines of said first subset of said given run abut the axially extending pleat ends of the first subset of the adjacent run to one lateral side thereof along said second lateral direction, and wherein the axially extending pleat bend lines of said second subset of said given run abut the axially extending pleat bend lines of the second subset of the adjacent run to the opposite lateral side along said second lateral direction.

12. A method for making a filter for filtering fluid flowing along an axial flow direction along a flow axis from upstream to downstream, comprising providing a sheet of filter media, corrugating said sheet in a serpentine sinusoidal pattern along a set of pleat bend lines extending axially to form a plurality of axially extending fluted flow channels, and folding said corrugated sheet back and forth upon itself along a plurality of runs between a plurality of folds including upstream folds at a first set of fold lines and downstream folds at a second set of fold lines, the serpentine sinusoidal pattern extending along an abscissa along a first lateral direction relative to said flow axis, and extending along an ordinate along a second lateral direction relative to said flow axis, the serpentine sinusoidal pattern having peaks and valleys laterally varying from said abscissa along the direction of said ordinate, said first and second lateral directions being perpendicular to each other, each of said first and second lateral directions being perpendicular to said flow axis, said fluted flow channels comprising first and second sets of alternating flow channels, said first set of flow channels having closed upstream ends and open downstream ends, said second set of flow channels having open upstream ends and closed downstream ends.

13. The method according to claim 12 comprising aligning the peaks and valleys of a given run laterally along said second lateral direction with the valleys and peaks, respectively, of an adjacent run to form said fluted flow channels.

14. The method according to claim 13 comprising:
closing said upstream ends of said first set of flow channels with upstream channel-closure face portions of said filter media sheet facing axially and extending laterally in each of said first and second lateral directions across a respective flow channel between a respective peak and valley;
closing said downstream ends of said second set of flow channels with downstream channel-closure face portions of said filter media sheet facing axially and extending laterally in each of said first and second lateral directions across a respective flow channel between a respective peak and valley.

15. The method according to claim 14 comprising:
extending said upstream channel-closure face portions of said filter media sheet along said upstream folds along said first set of fold lines along said first lateral direction and alternating between maximum and minimum width sections along a width dimension along said second lateral direction, providing said maximum width sections with a saddle shape spanning laterally along said first lateral direction between respective minimum width sections and curved along an arc bowed in said axial flow direction and spanning laterally along said second lateral direction between a respective peak and valley of adjacent runs;
extending said downstream channel-closure face portions of said filter media sheet along said downstream folds along said second set of fold lines along said first lateral direction and alternating between maximum and minimum width sections along a width dimension along said second lateral direction, and providing said maximum width sections of said downstream channel-closure face portions having a saddle shape spanning laterally along said first lateral direction between respective minimum width sections of said downstream channel-closure face portions and curved along an arc bowed in said axial flow direction and spanning along said second lateral direction between a respective peak and valley of adjacent runs.

16. The method according to claim 15 comprising:
spanning said upstream channel-closure face portions of said filter media sheet along said first lateral direction along said arc and bowing said arc axially downstream into respective said flow channels;
spanning said downstream channel-closure face portions of said filter media sheet along said first lateral direction along said arc and bowing said arc axially upstream into respective said flow channels.

17. The method according to claim 15 comprising corrugating said filter media sheet in said serpentine sinusoidal pattern along said set of pleat bend lines to define pleat tips extending axially and having a shape selected from the group consisting of curved pleat tips and pointed pleat tips.

18. The method according to claim 15 comprising forming each of said saddle shapes with saddle tips selected from the group consisting of rounded tips and pointed tips.

19. The method according to claim 18 comprising forming at least one of said saddle shapes as a dihedral shape.

20. The method according to claim 14 comprising:
closing said upstream ends of said first set of flow channels solely with said upstream channel-closure face portions of said filter media sheet, eliminating the need for sealing said upstream ends of said first set of flow channels;
closing said downstream ends of said second set of flow channels solely with said downstream channel-closure face portions of said filter media sheet, eliminating the need for sealing said downstream ends of said second set of flow channels.
